(19) United States
(12) Patent Application Publication
(10) Pub. No.: US 2010/0133019 A1
(43) Pub. Date: Jun. 3, 2010

(54) AGRICULTURAL TRACTOR

(76) Inventor: Philipp Muemken, Muenster (DE)

Correspondence Address: Striker, Striker & Stenby, 103 East Neck Road, Huntington, NY, 11743, US

(21) Appl. No.: 12/616,863

(22) Filed: Nov. 12, 2009

(30) Foreign Application Priority Data
Nov. 28, 2008 (DE) 10 2008 059 467.9

(51) Int. Cl. B62D 55/00

(52) U.S. Cl. 180/9.21

(57) ABSTRACT

In an agricultural tractor system, an engine-cab unit and a front ground-drive part are combined to form one front assembly. The front assembly may be joined, in a modular fashion, to a first rear ground-drive part or to a second rear ground-drive part which is structurally different from the first rear ground-drive part, in order to form a driveable tractor.

### CROSS-REFERENCE TO A RELATED APPLICATION

The invention described and claimed hereinbelow is also described in German Patent Application DE 10 2008 059 467.9 filed on Nov. 28, 2008. This German Patent Application, whose subject matter is incorporated here by reference, provides the basis for a claim of priority of invention under 35 U.S.C. 119(a)-(d).

### BACKGROUND OF THE INVENTION

The present invention relates to an agricultural tractor, and focuses on, although is not limited to, a tractor comprising at least one crawler track assembly.

Agricultural tractors which include a crawler track assembly are known in many forms, e.g., from EP 0 000 211 B1. In comparison to a ground drive comprising individual wheels, a crawler track assembly makes it possible to distribute the weight of the tractor over a large surface area of the ground, thereby allowing a heavy tractor to also be used on ground surfaces that are sensitive to high loads. Since the production of a crawler track assembly is much more complex than that of a ground drive comprising individual wheels, tractors which include a crawler track assembly are therefore more expensive than are machines which include a conventional ground drive. They therefore comprise only a small portion of all of the agricultural tractors in use. As a result, they are manufactured in small production series, which greatly increases the costs of these machines.

### SUMMARY OF THE INVENTION

The object of the present invention, therefore, is to create a concept for agricultural tractors that results in the largely uniform production of machines having a crawler track assembly and a conventional ground drive, thereby enabling the parts common to both machines to be manufactured in a uniform manner and, therefore in a larger production series, which has cost advantages.

The object is attained via an agricultural tractor system in which an engine-cab unit and a front ground-drive part are combined to form one front assembly, and the front assembly may be joined, in a modular fashion, to a first rear ground-drive part or to the second rear ground-drive part which is structurally different from the first rear ground-drive part, in order to form a driveable tractor. The front assembly may therefore be manufactured identically and economically in large production runs for a large number of tractor types; the cost disadvantages associated with a smaller production series usually involve the rear ground-drive parts, and not the entire machine.

The design differences between the at least two different rear ground-drive parts may be, in particular, that the first rear ground-drive part includes at least one wheel pair, and the second rear ground-drive part includes two track roller units.

According to a first embodiment, the wheels or track roller units may comprise substantially all of the rear ground-drive parts, and they may be mountable on the same axle of the tractor.

According to a second embodiment, the rear ground-drive parts may each include a carrier in addition to the wheels or track roller units; the wheels are rotatably mounted on the carrier of the first rear ground-drive part, and the two track roller units are mounted on the carrier of the second rear ground-drive part.

It is also feasible to combine the two designs by making it possible to swap the wheels and track roller units on at least one of the carriers. It may also be possible for a swap of this type to be carried out by an operator, although joining the front assembly and the rear ground-drive part may be a substantially more complex procedure, which may possibly be so complex that it is carried out only when the tractor is manufactured or undergoes repair work.

Preferably, each of the track roller units includes a central driven roller situated between non-driven front and rear deflection rollers. A track roller unit of this type is easily converted from crawler track operation to wheel operation by removing the crawler track, possibly removing the deflection rollers, and replacing the driven roller.

There are various possibilities for steering a tractor of the system according to the present invention, one or two of which is/are preferably realized simultaneously in the same tractor:
the front ground-drive part is steerable;
the wheels of the first rear ground-drive part and/or the roller track units of the second rear ground-drive part may be folded inward against their carriers;
the carrier of the first and/or second rear ground-drive part may be folded inward relative to the engine-cab unit;
the carrier of the first and/or second rear ground-drive part may be folded inward relative to the engine-cab unit.

There are two variants, in particular, for the latter case: The rear ground-drive part may be connected to the front assembly such that it is pivotable about a vertical axis, i.e., the rear ground-drive part may be inherently rigid, or the rear ground-drive part includes, in addition to the carrier, a bridge part which is fixedly connected to the front assembly; the carrier is located underneath the bridge part, and it is pivotable about a vertical axis, toward the bridge part.

Since the front ground-drive part of an agricultural tractor usually carries a lighter weight than does the rear ground-drive part, it is generally sufficient for the front ground-drive part to have a single axis. The front assembly is therefore not stable on its own, nor is it driveable. Only when it is combined with the rear ground-drive part is a driveable machine attained.

Preferably, more than one axle may be provided on the rear ground-drive part, since it is usually loaded to a greater extent than is the front ground-drive part.

An adapter for a device to be pulled is preferably provided on the rear ground-drive parts. Potential adapters include a trailer hitch, a hydraulic lift, and a saddle.

When the rear ground-drive part includes a bridge part and a rotatable carrier installed underneath it, then the adapter is preferably located on the bridge part.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic side view of an agricultural tractor, according to the present invention, which includes a first type of rear ground-drive part;

FIG. 2 shows a schematic side view of the tractor including a second type of rear ground-drive part;

FIG. 3 shows a side view of the tractor including a third type of rear ground-drive part;

FIG. 4 shows an example of the steering of the tractor;

FIG. 5 shows a second example of the steering of the tractor;

FIG. 6 shows a third example of the steering of the tractor;

FIG. 7 shows a side view of the tractor including a fourth type of rear ground-drive part;

FIG. 8 shows a side view of the tractor in FIG. 7, which includes a rear ground-drive part which has been converted from crawler track drive to wheel drive;

FIG. 9 shows a side view of a variant of the tractor in FIG. 7 during the conversion from crawler track drive to wheel drive; and

FIG. 10 shows the tractor in FIG. 9, converted to wheel drive.

### DESCRIPTION OF THE PREFERRED EMBODIMENTS

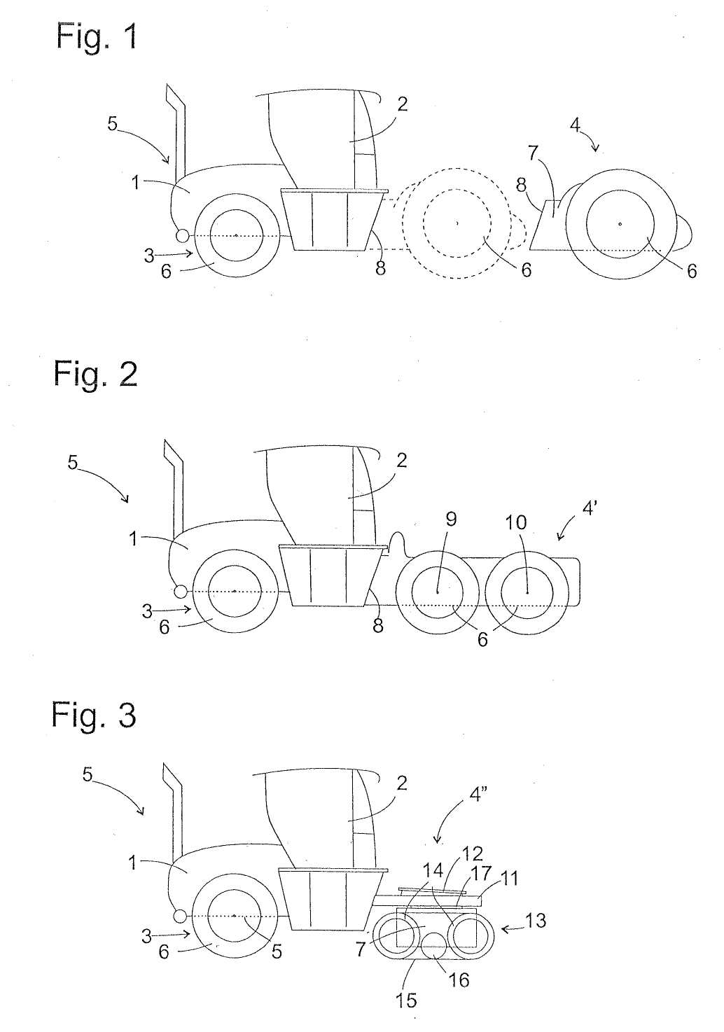

FIG. 1 shows a highly schematicized side view of an agricultural tractor according to a first embodiment of the present invention. The tractor is divided into two modules: a front module 5 and a rear module 4. Front module 5 includes an engine housing 1, a driver's cab 2, and a front ground-drive part 3. Front ground-drive part 3 includes an axle having wheels 6 which are steered via a steering knuckle and include air-filled tires.

Rear module 4 includes a carrier block 7 having a rear axle on which wheels 6 comprising air-filled tires are mounted. The rear axle may be a rigid axle, or it may be steerable, like the front axle, in order to improve the maneuverability of the tractor, in particular to reduce its turning clearance circle and to enable travel in a “dog walking” manner.

At an interface 8 between the modules, a drive shaft, e.g., extends from the engine in front module 5 to wheels 6 of rear module 4.

Rear module 4 is shown separately from front module 5 using solid lines, and it is shown connected to front module 5 using dashed lines, in order to indicate that modules 4, 5 are preassembled separately and are joined together in a subsequent phase of the tractor assembly. This makes it possible to use front module 5 in conjunction with rear modules having a design that differs from that shown in FIG. 1.

An example of the combination of front module 5 with another type of rear module is shown in FIG. 2. In this case, rear module 4′ includes two axles 9, 10 comprising air-filled tires, in order to distribute a high load, e.g., of a trailer supported on rear module 4′, or a ground working tool that is carried in a freely hanging manner, over a larger ground surface area than is possible using the single axle of rear module 4.

Axles 9, 10 may be rigid axles. To improve the ability of tractor to travel around curves, preferably at least one rear axle 10 is steerable. Both axles 9, 10 must be steerable for dog-walking travel to be possible. Each axle 9, 10 may be controlled individually using steering knuckles, or a common carrier block of both axles 9, 10 may form a fifth wheel which is rotatable about a vertical axle and toward a bridge part—which is fixedly connected to front module 5—of rear module 4′.

FIG. 3 shows a tractor having the same front module 5 as that described above, and a modified rear module 4″. Rear module 4″ is composed mainly of a bridge part 11, which extends in the longitudinal direction of the tractor, is oriented substantially horizontally, is rigidly attached to front module 5, and includes a saddle 12 for a saddle support, and is composed of a crawler track assembly having a carrier block 7 which is located underneath bridge part 11 and is interconnected therewith via a flange joint 17, and track roller units 13 located on either side of carrier block 7. Each track roller unit 13 includes a front and a rear deflection roller 16, a track belt 15 wound around deflection rollers 14, and a support roller 16 which is located in an intermediate space between the two deflection rollers 14 in contact with a section of roller belt 15 lying on the ground, in order to distribute the weight resting on rear module 4″ as evenly as possible along the entire length of the section lying on the ground. Depending on the distance between deflection rollers 14, it is also possible to eliminate the support roller 16, or more than one support roller 16 per track roller unit 13 may be provided.

In the case of front ground-drive part 3 and rear modules 4 and 4′, the extension of the ground-contact surface is determined mainly by the diameter and number of wheels 6; however, in the case of a crawler track assembly, such as that belonging to rear module 4″, the distance between deflection rollers 14 is the main determining factor of the extension of the ground-contact surface. As shown in FIG. 3, the diameter of deflection rollers 14 may therefore be smaller than the diameter of wheels 6, and, in particular, it may be smaller than the ground clearance of bridge part 11. When the crawler track assembly is turned for steering, it is therefore possible for deflection rollers 14 of the crawler track assembly to move unencumbered underneath bridge part 11, and the steering angle is not limited by the possibility that the wheels may strike bridge part 11, as could happen in the case of the embodiment shown in FIG. 2.

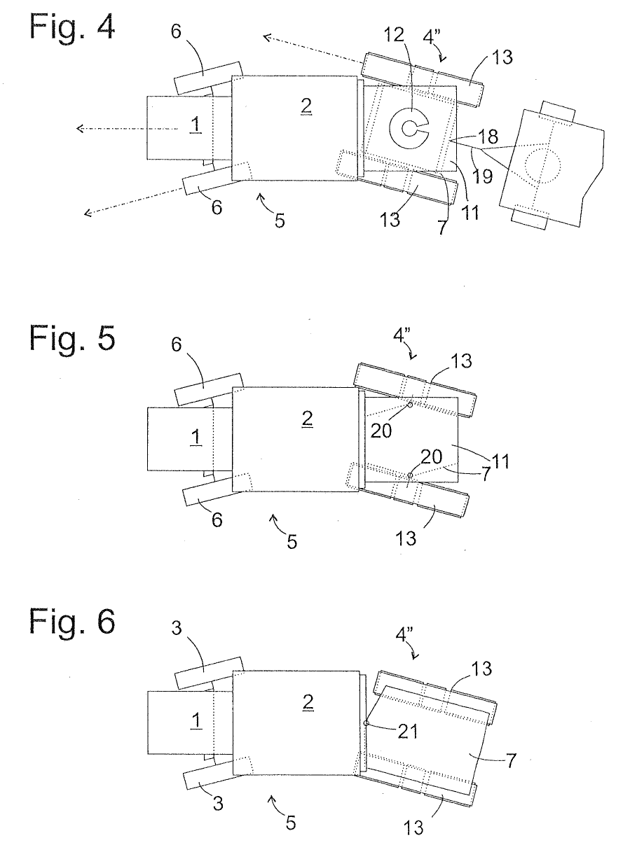

FIG. 4 shows a top view of the tractor in FIG. 3, and is used to illustrate the mode of operation of its steering. Wheels 6, which are steered using steering knuckles, are located on front module 5. They are turned to the left relative to the longitudinal direction of the tractor; the longitudinal direction and rolling direction of wheels 6 are indicated using dash-dotted arrows. Carrier 7 is turned in the opposite direction, and so the crawler track assembly supports the travel around the curve. In an alternative operating mode, the carrier is turned in the same direction as wheels 6 of front module 5; in this operating mode known as “dog walking”, the tracks of wheels 6 and track roller unit 13 are offset in parallel to one another in order to distribute the machine load on the ground as evenly as possible.

The rotational axis of flange joint 17 coincides with the center point of saddle 12, and therefore braking forces applied by a trailer lying on the saddle do not affect the rotation of carrier 7. A coupling 18 for a trailer drawbar 19 or a ground-working tool drawn behind is located on carrier 7, since the rear end of bridge part 11 swivels outward when passing around a curve, and there is a risk that a trailer drawbar coupled thereto could tilt.

An alternative design of the steering of the tractor is shown in FIG. 5. In this case, each track roller unit 13 may swivel individually about separate axes 20 relative to carrier 7, and carrier 7 itself is stationary. In this design, the swing of track roller units 13 in the longitudinal direction of the tractor is less than it is in the case of the fifth-wheel design shown in FIG. 4, and so large turning angles are easier to realize.

In the embodiment shown in FIG. 6, front and rear modules 5, 4″ are connected in a joint 21 to a vertical axis, and the machine is steerable by turning front wheels 6, and via the swivel motion of both modules 4″, 5 opposite one another in joint 21.

Of course, rear module 4″ which includes a crawler track assembly and which is shown as an example may be replaced in the machines shown in FIGS. 4 through 6 with rear modules having wheels, such as 4 and 4′, or with one of the rear modules 4′″, 4″″ to be described below.

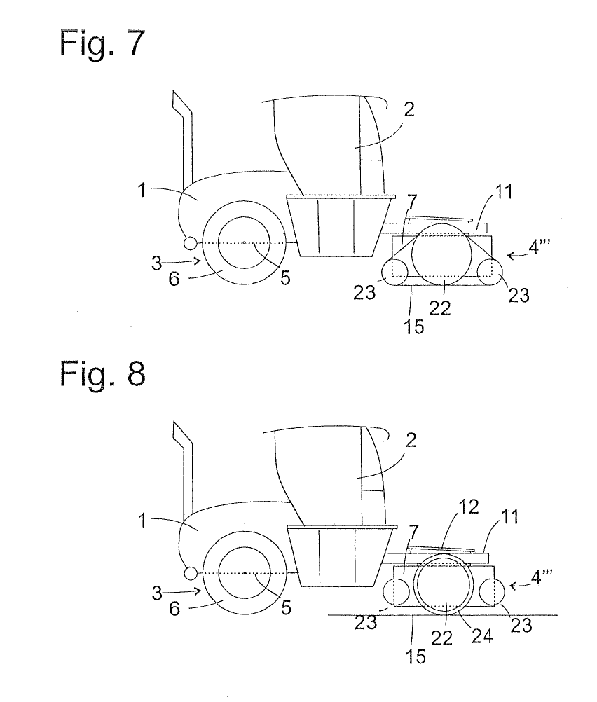

FIG. 7 shows the tractor according to a fourth embodiment of the present invention. In this case, rear module 4′″ of the machine is designed as a stacked crawler track, that is, each track roller unit 13 includes a central drive roller 22, and it includes a non-driven deflection roller 23 in front (in the direction of travel) of it and one behind it, the diameters of which are much smaller than that of drive roller 22. The diameter of drive roller 22 is greater than the ground clearance of bridge part 11, but since the deflection rollers may move underneath bridge part 11 when swiveling, the pivot movement freedom of rear module 4′″ is not necessarily less than that of a module having wheels of the size of drive rollers 22.

In addition to the relative great pivot movement freedom, a further advantage of the stacked roller track is convertibility. FIG. 8 shows a view of the tractor in FIG. 7, in which track belt 15 is open and lies flat on the ground. Deflection rollers 22 are offset on carrier block 7 in a raised position, and have no ground contact. When the tractor moves forward in this configuration, drive rollers 23 act as wheels.

To improve the driving behavior when the wheels are used, drive rollers 22 may be provided with an elastic enclosure 24.

The operator may convert rear module 4′″ from roller track operation to wheel-driven operation and back as necessary.

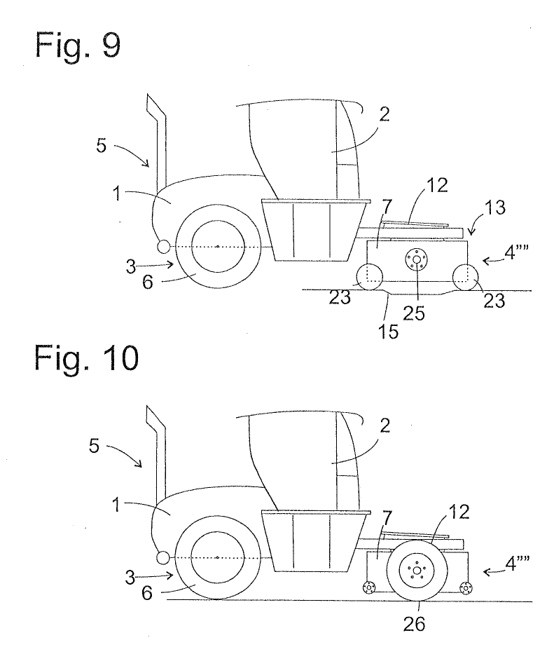

A further embodiment of a convertible rear module 4″″ is shown in FIGS. 9 and 10. In roller track operation, rear module 4″″ does not differ externally from module 4′″ in FIG. 7. FIG. 9 shows an intermediate stage of the conversion from roller track operation to wheel-driven operation. Track belt 15 on both roller track units 13 has been opened, drive roller 22 has been removed, and a carrier flange of drive axle 25 is visible. Module 4″″ rests on deflection rollers 23. The ground level at deflection rollers 23 is slightly higher than it is under drive axle 25. It is therefore possible to mount a wheel 26—which may include an air-filled tire—on the flange of drive axle 25; the diameter of wheel 26 is slightly greater than that of drive roller 22 which has been removed. When the machine moves, wheels 26 come in contact with the ground, and deflection rollers 23 become unloaded and may be easily removed. The configuration shown in FIG. 10 attained, in which wheel-driven operation is possible.

It will be understood that each of the elements described above, or two or more together, may also find a useful application in other types of constructions differing from the types described above.

While the invention has been illustrated and described as embodied in an agricultural tractor, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An agricultural tractor system, comprising an engine-cab unit; a front ground-drive part; a first rear ground-drive part, a second rear ground-drive part which is structurally different from said first rear ground-drive part, wherein said engine-cab unit and said front ground-drive part constitute a front assembly which is joinable in a modular fashion to said first rear ground-drive part or to at least said second rear ground-drive part, in order to form a driveable tractor.

2. The agricultural tractor system as defined in claim 1, wherein said first rear ground-drive part includes at least one wheel pair, and said second rear ground-drive part includes two track roller units which are installable on a same axle as said at least one wheel pair.

3. The agricultural tractor system as defined in claim 1, wherein said first rear ground-drive part includes at least one wheel pair and a carrier on which wheels of said wheel pair are rotatably mounted, and said second rear ground-drive part includes two track roller units and a carrier on which said two track roller units are mounted.

4. The agricultural tractor as defined in claim 3, wherein each of said track roller units includes a centrally driven roller situated between non-driven front and rear deflection rollers.

5. The agricultural tractor system as defined in claim 3, wherein the wheels and the roller track units on at least one of said carriers are swappable.

6. The agricultural tractor system as defined in claim 3, wherein components selected from the group consisting of the wheels of said first rear ground-drive part, the roller track units of said second rear ground-drive part, and both are foldable toward their carriers.

7. The agricultural tractor system as defined in claim 3, wherein said carrier selected from the group consisting a carrier of said first rear ground-drive part, said second rear ground-drive part, and both is foldable inwards relative to said engine-cab unit.

8. The agricultural tractor system as defined in claim 7, wherein said rear ground-drive part is connected to said front assembly such that it is pivotable about a vertical axis.

9. The agricultural tractor system as defined in claim 7, wherein said rear ground-drive part includes a bridge part which is fixedly connected to said front assembly, and said carrier is located underneath said bridge part and is pivotable about a vertical axis toward said bridge part.

10. The agricultural tractor system as defined in claim 1, wherein said front ground-drive part is steerable.

11. The agricultural tractor system as defined in claim 1, wherein said front ground-drive part includes a single axle.

12. The agricultural tractor system as defined in claim 1, wherein each of said rear ground-drive parts includes at least one adapter for a device to be pulled.

13. The agricultural tractor as defined in claim 12, wherein said at least one adapter is an adaptor selected from the group consisting of a trailer hitch, a hydraulic lift, and a saddle.

14. The agricultural tractor as defined in claim 12, wherein said adapter is installed on a bridge part of said rear ground-drive part.
